(19) United States
(12) Patent Application Publication
(10) Pub. No.: US 2025/0132859 A1
(43) Pub. Date: Apr. 24, 2025

(54) UHR CONTROL FRAME AND MAC HEADER PROTECTION WITH KEY MANAGEMENT

(71) Applicants: Po-Kai Huang, San Jose, CA (US); Danny Alexander, Neve Efraim Monoson (IL); Danny Ben-Ari, Tsur Natan (IL); Oded Liron, Givat-Ada HA (IL); Ido Ouzieli, Tel Aviv (IL); Ilan Peer, Modiin JM (IL); Johannes Berg, Detmold (DE)

(72) Inventors: Po-Kai Huang, San Jose, CA (US); Danny Alexander, Neve Efraim Monoson (IL); Danny Ben-Ari, Tsur Natan (IL); Oded Liron, Givat-Ada HA (IL); Ido Ouzieli, Tel Aviv (IL); Ilan Peer, Modiin JM (IL); Johannes Berg, Detmold (DE)

(21) Appl. No.: 19/003,020

(22) Filed: Dec. 27, 2024

Related U.S. Application Data
(60) Provisional application No. 63/619,198, filed on Jan. 9, 2024.
(60) Provisional application No. 63/556,669, filed on Feb. 22, 2024.

(51) Int. Cl. H04L 1/00; H04L 5/00; H04W 12/041; H04W 12/106

(52) U.S. Cl. CPC H04L 1/0008; H04L 5/0053; H04W 12/041; H04W 12/106

(57) ABSTRACT

An ultra-high reliability station (UHR STA) requests that medium access control (MAC) header protection padding be included in an MAC Protocol Data Unit (MPDU). A protected control frame may be received from the UHR AP comprising an MPDU that includes a MAC header protection padding field. The MAC header protection padding field may comprise padding to allow for additional time for the processing circuitry to compute the MIC before sending the ACK. For multi-link operations (MLOs) when MAC header protection padding is used, each link may be configured with an independent replay counter and a different key is used for the protected control frame and a protected MAC header in each link. The independent replay counter in each link is reset to zero when the key is derived or rekeyed and set to a packet or sequence number (PN or SN) of the protected control frame or protected MAC header when the MIC is verified.

### PRIORITY CLAIMS

This application claims priority under 35 U.S.C. 119(e) to U.S. Provisional Patent Application Ser. No. 63/556,669, filed Feb. 22, 2024 [reference number AF9453-Z], and U.S. Provisional Patent Application Ser. No. 63/619,198 filed Jan. 9, 2024 [reference number AF8759-Z], which are incorporated herein by reference in their entireties.

### TECHNICAL FIELD

Embodiments pertain to wireless communications. Some embodiments relate to wireless local area networks (WLANs).

### BACKGROUND

Wireless devices are becoming widely prevalent and are increasingly requesting access to wireless channels. The Institute of Electrical and Electronics Engineers (IEEE) is developing one or more standards for wireless local area networks (WLANs) that utilize Orthogonal Frequency-Division Multiple Access (OFDMA) in channel allocation. One issue with WLANS is medium access control (MAC) header protection.

### BRIEF DESCRIPTION OF THE DRAWINGS

FIG. 1 is a block diagram of a radio architecture, in accordance with some embodiments.

FIG. 2 illustrates a front-end module circuitry for use in the radio architecture of FIG. 1, in accordance with some embodiments.

FIG. 3 illustrates a radio IC circuitry for use in the radio architecture of FIG. 1, in accordance with some embodiments.

FIG. 4 illustrates a baseband processing circuitry for use in the radio architecture of FIG. 1, in accordance with some embodiments.

FIG. 5 illustrates a WLAN, in accordance with some embodiments.

FIG. 6 illustrates a multi-link framework in accordance with some embodiments.

FIG. 7A illustrates a QoS Null frame transmission and an acknowledgement (ACK), in accordance with some embodiments.

FIG. 7B illustrates an A-MPDU transmission and a corresponding block acknowledgement, in accordance with some embodiments.

FIG. 8 illustrates an MPDU that includes MAC header protection padding in accordance with some embodiments.

FIG. 9 illustrates an MPDU that includes MAC header protection padding in accordance with some other embodiments.

FIG. 10 is a table 9-255 that illustrates subfields of an A-MPDU parameters field in accordance with some embodiments.

FIG. 11 is a procedure performed by a UHR STA for receiving an MPDU, in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Some embodiments are directed to an ultra-high reliability station (UHR STA) that requests that medium access control (MAC) header protection padding be included in an MAC Protocol Data Unit (MPDU). In these embodiments, a protected control frame may be received from the UHR AP comprising an MPDU that includes a MAC header protection padding field. In these embodiments the MAC header protection padding field may comprises padding to allow for additional time for the processing circuitry to compute the MIC before sending the ACK. These embodiments, as well as others, are described in more detail herein.

For multi-link operations (MLOs) when MAC header protection padding is used, each link may be configured with an independent replay counter and a different key is used for the protected control frame and a protected MAC header in each link. In these embodiments, the independent replay counter in each link is reset to zero when the key is derived or rekeyed and set to a packet or sequence number (PN or SN) of the protected control frame or protected MAC header when the MIC is verified. These embodiments, as well as others, are described in more detail herein.

MAC header protection in WLANs may use a Management Frame Protection (MFP) protocol to prevent unauthorized manipulation of management frames. It includes a cryptographic hash (MIC) added to management frames, protected frames contain timestamp, sequence number, and source/destination addresses, requires PMF (Protected Management Frames) capability on both AP and client, and may be part of the WPA3 security framework but optional in WPA2. This prevents attacks like de-authentication floods and evil twin APs by ensuring frame authenticity and integrity.

FIG. 1 is a block diagram of a radio architecture 100 in accordance with some embodiments. Radio architecture 100 may include radio front-end module (FEM) circuitry 104, radio IC circuitry 106 and baseband processing circuitry 108. Radio architecture 100 as shown includes both Wireless Local Area Network (WLAN) functionality and Bluetooth (BT) functionality although embodiments are not so limited. In this disclosure, “WLAN” and “Wi-Fi” are used interchangeably.

FEM circuitry 104 may include a WLAN or Wi-Fi FEM circuitry 104A and a Bluetooth (BT) FEM circuitry 104B. The WLAN FEM circuitry 104A may include a receive signal path comprising circuitry configured to operate on WLAN RF signals received from one or more antennas 101, to amplify the received signals and to provide the amplified versions of the received signals to the WLAN radio IC circuitry 106A for further processing. The BT FEM circuitry 104B may include a receive signal path which may include circuitry configured to operate on BT RF signals received from one or more antennas 101, to amplify the received signals and to provide the amplified versions of the received signals to the BT radio IC circuitry 106B for further processing. FEM circuitry 104A may also include a transmit signal path which may include circuitry configured to amplify WLAN signals provided by the radio IC circuitry 106A for wireless transmission by one or more of the antennas 101. In addition, FEM circuitry 104B may also include a transmit signal path which may include circuitry configured to amplify BT signals provided by the radio IC circuitry 106B for wireless transmission by the one or more antennas. In the embodiment of FIG. 1, although FEM CIRCUITRY 104A and FEM CIRCUITRY 104B are shown as being distinct from one another, embodiments are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 106 as shown may include WLAN radio IC circuitry 106A and BT radio IC circuitry 106B. The WLAN radio IC circuitry 106A may include a receive signal path which may include circuitry to down-convert WLAN RF signals received from the FEM circuitry 104A and provide baseband signals to WLAN baseband processing circuitry 108A. BT radio IC circuitry 106B may in turn include a receive signal path which may include circuitry to down-convert BT RF signals received from the FEM circuitry 104B and provide baseband signals to BT baseband processing circuitry 108B. WLAN radio IC circuitry 106A may also include a transmit signal path which may include circuitry to up-convert WLAN baseband signals provided by the WLAN baseband processing circuitry 108A and provide WLAN RF output signals to the FEM circuitry 104A for subsequent wireless transmission by the one or more antennas 101. BT radio IC circuitry 106B may also include a transmit signal path which may include circuitry to up-convert BT baseband signals provided by the BT baseband processing circuitry 108B and provide BT RF output signals to the FEM circuitry 104B for subsequent wireless transmission by the one or more antennas 101. In the embodiment of FIG. 1, although radio IC circuitries 106A and 106B are shown as being distinct from one another, embodiments are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuitry 108 may include a WLAN baseband processing circuitry 108A and a BT baseband processing circuitry 108B. The WLAN baseband processing circuitry 108A may include a memory, such as, for example, a set of RAM arrays in a Fast Fourier Transform or Inverse Fast Fourier Transform block (not shown) of the WLAN baseband processing circuitry 108A. Each of the WLAN baseband circuitry 108A and the BT baseband circuitry 108B may further include one or more processors and control logic to process the signals received from the corresponding WLAN or BT receive signal path of the radio IC circuitry 106, and to also generate corresponding WLAN or BT baseband signals for the transmit signal path of the radio IC circuitry 106. Each of the baseband processing circuitries 108A and 108B may further include physical layer (PHY) and medium access control layer (MAC) circuitry and may further interface with application processor 111 for generation and processing of the baseband signals and for controlling operations of the radio IC circuitry 106.

Referring still to FIG. 1, according to the shown embodiment, WLAN-BT coexistence circuitry 113 may include logic providing an interface between the WLAN baseband circuitry 108A and the BT baseband circuitry 108B to enable use cases requiring WLAN and BT coexistence. In addition, a switch 103 may be provided between the WLAN FEM circuitry 104A and the BT FEM circuitry 104B to allow switching between the WLAN and BT radios according to application needs. In addition, although the antennas 101 are depicted as being respectively connected to the WLAN FEM circuitry 104A and the BT FEM circuitry 104B, embodiments include within their scope the sharing of one or more antennas as between the WLAN and BT FEMs, or the provision of more than one antenna connected to each of FEM circuitry 104A or FEM circuitry 104B.

In some embodiments, the front-end module circuitry 104, the radio IC circuitry 106, and baseband processing circuitry 108 may be provided on a single radio card, such as wireless radio card 102. In some other embodiments, the one or more antennas 101, the FEM circuitry 104 and the radio IC circuitry 106 may be provided on a single radio card. In some other embodiments, the radio IC circuitry 106 and the baseband processing circuitry 108 may be provided on a single chip or integrated circuit (IC), such as IC 112.

In some embodiments, the wireless radio card 102 may include a WLAN radio card and may be configured for Wi-Fi communications, although the scope of the embodiments is not limited in this respect. In some of these embodiments, the radio architecture 100 may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers.

In some of these multicarrier embodiments, radio architecture 100 may be part of a Wi-Fi communication station (STA) such as a wireless access point (AP), a base station or a mobile device including a Wi-Fi device. In some of these embodiments, radio architecture 100 may be configured to transmit and receive signals in accordance with specific communication standards and/or protocols, such as any of the Institute of Electrical and Electronics Engineers (IEEE) standards including, IEEE 802.11n-2009, IEEE 802.11-2012, IEEE 802.11-2016, IEEE 802.11ac, IEEE 802.11ax, IEEE P802.11be and/or IEEE P802.11bn standards and/or proposed specifications for WLANs, although the scope of embodiments is not limited in this respect. Radio architecture 100 may also be suitable to transmit and/or receive communications in accordance with other techniques and standards.

In some embodiments, the radio architecture 100 may be configured for high-efficiency (HE) Wi-Fi (HEW) communications in accordance with the IEEE 802.11ax standard. In some embodiments, the radio architecture 100 may be configured for Extremely High Throughput (EHT) communications in accordance with the IEEE 802.11be standard. In these embodiments, the radio architecture 100 may be configured to communicate in accordance with an OFDMA technique, although the scope of the embodiments is not limited in this respect. In some embodiments, the radio architecture 100 may be configured for next generation vehicle-to-everything (NGV) communications in accordance with the IEEE 802.11bd standard and one or more stations including AP 502 may be next generation vehicle-to-everything (NGV) stations (STAs).

In some other embodiments, the radio architecture 100 may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, as further shown in FIG. 1, the BT baseband circuitry 108B may be compliant with a Bluetooth (BT) connectivity standard such as Bluetooth, Bluetooth 4.0 or Bluetooth 5.0, or any other iteration of the Bluetooth Standard. In embodiments that include BT functionality as shown for example in FIG. 1, the radio architecture 100 may be configured to establish a BT synchronous connection oriented (SCO) link and/or a BT low energy (BT LE) link. In some of the embodiments that include functionality, the radio architecture 100 may be configured to establish an extended SCO (eSCO) link for BT communications, although the scope of the embodiments is not limited in this respect. In some of these embodiments that include a BT functionality, the radio architecture may be configured to engage in a BT Asynchronous Connection-Less (ACL) communications, although the scope of the embodiments is not limited in this respect. In some embodiments, as shown in FIG. 1, the functions of a BT radio card and WLAN radio card may be combined on a single wireless radio card, such as single wireless radio card 102, although embodiments are not so limited, and include within their scope discrete WLAN and BT radio cards.

In some embodiments, the radio architecture 100 may include other radio cards, such as a cellular radio card configured for cellular (e.g., 3GPP such as LTE, LTE-Advanced or 5G communications).

In some IEEE 802.11 embodiments, the radio architecture 100 may be configured for communication over various channel bandwidths including bandwidths having center frequencies of about 900 MHz, 2.4 GHz, 5 GHz, and bandwidths of about 1 MHz, 2 MHz, 2.5 MHz, 4 MHz, 5 MHz, 8 MHz, 10 MHz, 16 MHz, 20 MHz, 40 MHz, 80 MHz (with contiguous bandwidths) or 80+80 MHz (160 MHz) (with non-contiguous bandwidths). In some embodiments, a 320 MHz channel bandwidth may be used. The scope of the embodiments is not limited with respect to the above center frequencies, however.

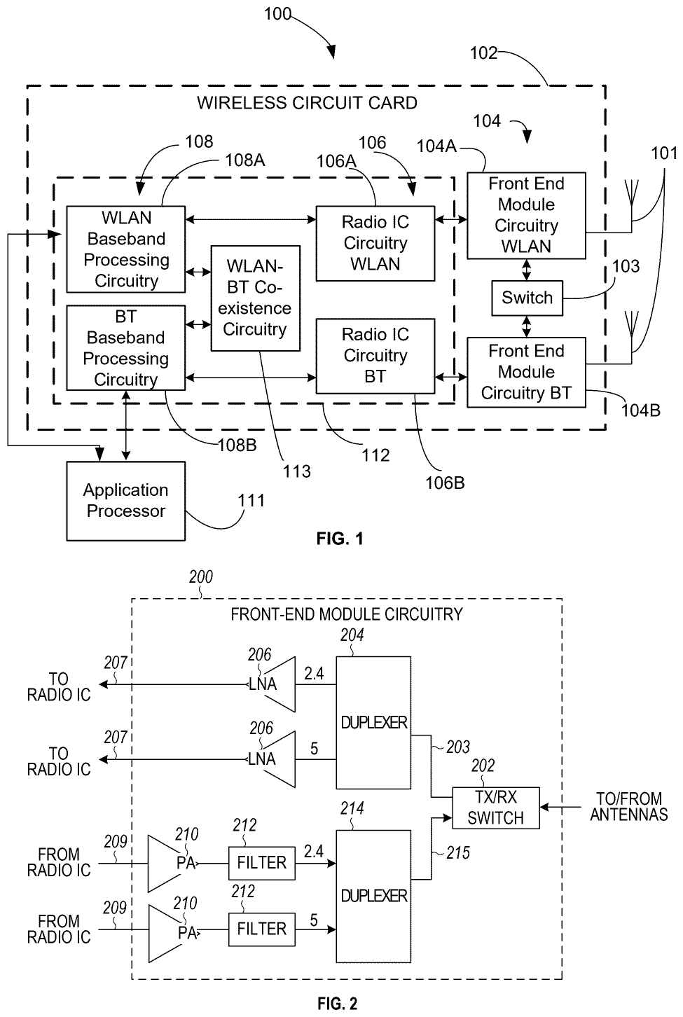

FIG. 2 illustrates FEM circuitry 200 in accordance with some embodiments. The FEM circuitry 200 is one example of circuitry that may be suitable for use as the WLAN and/or BT FEM circuitry 104A/104B (FIG. 1), although other circuitry configurations may also be suitable.

In some embodiments, the FEM circuitry 200 may include a TX/RX switch 202 to switch between transmit mode and receive mode operation. The FEM circuitry 200 may include a receive signal path and a transmit signal path. The receive signal path of the FEM circuitry 200 may include a low-noise amplifier (LNA) 206 to amplify received RF signals 203 and provide the amplified received RF signals 207 as an output (e.g., to the radio IC circuitry 106 (FIG. 1)). The transmit signal path of the circuitry 200 may include a power amplifier (PA) to amplify input RF signals 209 (e.g., provided by the radio IC circuitry 106), and one or more filters 212, such as band-pass filters (BPFs), low-pass filters (LPFs) or other types of filters, to generate RF signals 215 for subsequent transmission (e.g., by one or more of the antennas 101 (FIG. 1)).

In some dual-mode embodiments for Wi-Fi communication, the FEM circuitry 200 may be configured to operate in either the 2.4 GHz frequency spectrum or the 5 GHz frequency spectrum. In these embodiments, the receive signal path of the FEM circuitry 200 may include a receive signal path duplexer 204 to separate the signals from each spectrum as well as provide a separate LNA 206 for each spectrum as shown. In these embodiments, the transmit signal path of the FEM circuitry 200 may also include a power amplifier 210 and a filter 212, such as a BPF, a LPF or another type of filter for each frequency spectrum and a transmit signal path duplexer 214 to provide the signals of one of the different spectrums onto a single transmit path for subsequent transmission by the one or more of the antennas 101 (FIG. 1). In some embodiments, BT communications may utilize the 2.4 GHZ signal paths and may utilize the same FEM circuitry 200 as the one used for WLAN communications.

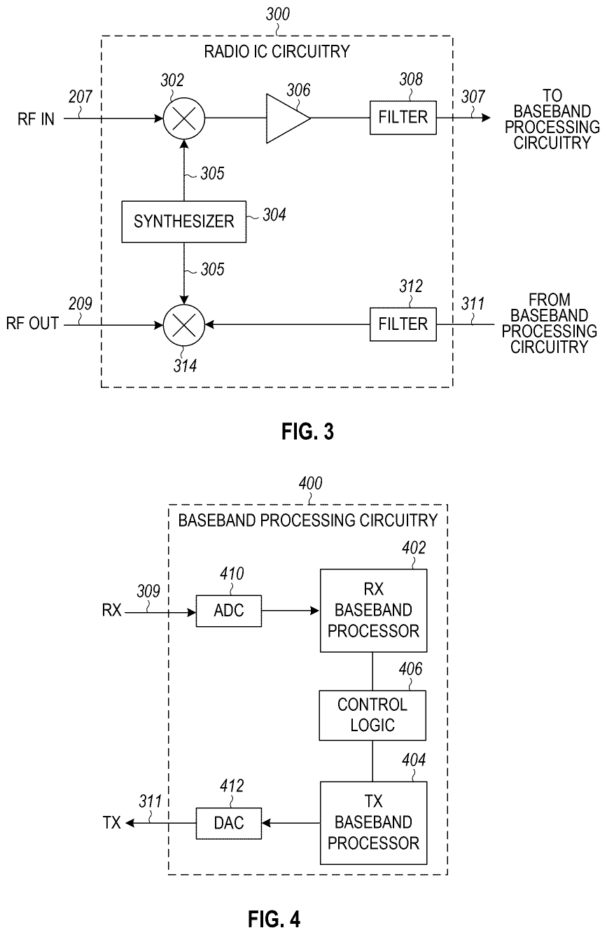

FIG. 3 illustrates radio IC circuitry 300 in accordance with some embodiments. The radio IC circuitry 300 is one example of circuitry that may be suitable for use as the WLAN or BT radio IC circuitry 106A/106B (FIG. 1), although other circuitry configurations may also be suitable.

In some embodiments, the radio IC circuitry 300 may include a receive signal path and a transmit signal path. The receive signal path of the radio IC circuitry 300 may include at least mixer circuitry 302, such as, for example, down-conversion mixer circuitry, amplifier circuitry 306 and filter circuitry 308. The transmit signal path of the radio IC circuitry 300 may include at least filter circuitry 312 and mixer circuitry 314, such as, for example, up-conversion mixer circuitry. Radio IC circuitry 300 may also include synthesizer circuitry 304 for synthesizing a frequency 305 for use by the mixer circuitry 302 and the mixer circuitry 314. The mixer circuitry 302 and/or 314 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 3 illustrates only a simplified version of a radio IC circuitry, and may include, although not shown, embodiments where each of the depicted circuitries may include more than one component. For instance, mixer circuitry 320 and/or 314 may each include one or more mixers, and filter circuitries 308 and/or 312 may each include one or more filters, such as one or more BPFs and/or LPFs according to application needs. For example, when mixer circuitries are of the direct-conversion type, they may each include two or more mixers.

In some embodiments, mixer circuitry 302 may be configured to down-convert RF signals 207 received from the FEM circuitry 104 (FIG. 1) based on the synthesized frequency 305 provided by synthesizer circuitry 304. The amplifier circuitry 306 may be configured to amplify the down-converted signals and the filter circuitry 308 may include a LPF configured to remove unwanted signals from the down-converted signals to generate output baseband signals 307. Output baseband signals 307 may be provided to the baseband processing circuitry 108 (FIG. 1) for further processing. In some embodiments, the output baseband signals 307 may be zero-frequency baseband signals, although this is not a requirement. In some embodiments, mixer circuitry 302 may comprise passive mixers, although the scope of the embodiments is not limited in this respect.

In some embodiments, the mixer circuitry 314 may be configured to up-convert input baseband signals 311 based on the synthesized frequency 305 provided by the synthesizer circuitry 304 to generate RF output signals 209 for the FEM circuitry 104. The baseband signals 311 may be provided by the baseband processing circuitry 108 and may be filtered by filter circuitry 312. The filter circuitry 312 may include a LPF or a BPF, although the scope of the embodiments is not limited in this respect.

In some embodiments, the mixer circuitry 302 and the mixer circuitry 314 may each include two or more mixers and may be arranged for quadrature down-conversion and/or up-conversion respectively with the help of synthesizer circuitry 304. In some embodiments, the mixer circuitry 302 and the mixer circuitry 314 may each include two or more mixers each configured for image rejection (e.g., Hartley image rejection). In some embodiments, the mixer circuitry 302 and the mixer circuitry 314 may be arranged for direct down-conversion and/or direct up-conversion, respectively. In some embodiments, the mixer circuitry 302 and the mixer circuitry 314 may be configured for super-heterodyne operation, although this is not a requirement.

Mixer circuitry 302 may comprise, according to one embodiment: quadrature passive mixers (e.g., for the in-phase (I) and quadrature phase (Q) paths). In such an embodiment, RF input signal 207 from FIG. 3 may be down-converted to provide I and Q baseband output signals to be sent to the baseband processor.

Quadrature passive mixers may be driven by zero and ninety-degree time-varying LO switching signals provided by a quadrature circuitry which may be configured to receive a LO frequency (f_{LO}) from a local oscillator or a synthesizer, such as LO frequency 305 of synthesizer circuitry 304 (FIG. 3). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety-degree time-varying switching signals may be generated by the synthesizer, although the scope of the embodiments is not limited in this respect.

In some embodiments, the LO signals may differ in duty cycle (the percentage of one period in which the LO signal is high) and/or offset (the difference between start points of the period). In some embodiments, the LO signals may have a 25% duty cycle and a 50% offset. In some embodiments, each branch of the mixer circuitry (e.g., the in-phase (I) and quadrature phase (Q) path) may operate at a 25% duty cycle, which may result in a significant reduction is power consumption.

The RF input signal 207 (FIG. 2) may comprise a balanced signal, although the scope of the embodiments is not limited in this respect. The I and Q baseband output signals may be provided to low-nose amplifier, such as amplifier circuitry 306 (FIG. 3) or to filter circuitry 308 (FIG. 3).

In some embodiments, the output baseband signals 307 and the input baseband signals 311 may be analog baseband signals, although the scope of the embodiments is not limited in this respect. In some alternate embodiments, the output baseband signals 307 and the input baseband signals 311 may be digital baseband signals. In these alternate embodiments, the radio IC circuitry may include analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 304 may be a fractional-N synthesizer or a fractional N/N+1 synthesizer, although the scope of the embodiments is not limited in this respect as other types of frequency synthesizers may be suitable. For example, synthesizer circuitry 304 may be a delta-sigma synthesizer, a frequency multiplier, or a synthesizer comprising a phase-locked loop with a frequency divider. According to some embodiments, the synthesizer circuitry 304 may include digital synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuitry 304 may be provided by a voltage-controlled oscillator (VCO), although that is not a requirement. A divider control input may further be provided by either the baseband processing circuitry 108 (FIG. 1) or application processor 111 (FIG. 1) depending on the desired output frequency 305. In some embodiments, a divider control input (e.g., N) may be determined from a look-up table (e.g., within a Wi-Fi card) based on a channel number and a channel center frequency as determined or indicated by application processor 111.

In some embodiments, synthesizer circuitry 304 may be configured to generate a carrier frequency as the output frequency 305, while in other embodiments, the output frequency 305 may be a fraction of the carrier frequency (e.g., one-half the carrier frequency, one-third the carrier frequency). In some embodiments, the output frequency 305 may be a LO frequency (f_{LO}).

FIG. 4 illustrates a functional block diagram of baseband processing circuitry 400 in accordance with some embodiments. The baseband processing circuitry 400 is one example of circuitry that may be suitable for use as the baseband processing circuitry 108 (FIG. 1), although other circuitry configurations may also be suitable. The baseband processing circuitry 400 may include a receive baseband processor (RX BBP) 402 for processing receive baseband signals 309 provided by the radio IC circuitry 106 (FIG. 1) and a transmit baseband processor (TX BBP) 404 for generating transmit baseband signals 311 for the radio IC circuitry 106. The baseband processing circuitry 400 may also include control logic 406 for coordinating the operations of the baseband processing circuitry 400.

In some embodiments (e.g., when analog baseband signals are exchanged between the baseband processing circuitry 400 and the radio IC circuitry 106), the baseband processing circuitry 400 may include ADC 410 to convert analog baseband signals received from the radio IC circuitry 106 to digital baseband signals for processing by the RX BBP 402. In these embodiments, the baseband processing circuitry 400 may also include DAC 412 to convert digital baseband signals from the TX BBP 404 to analog baseband signals.

In some embodiments that communicate OFDM signals or OFDMA signals, such as through baseband processing circuitry 108A, the transmit baseband processor 404 may be configured to generate OFDM or OFDMA signals as appropriate for transmission by performing an inverse fast Fourier transform (IFFT). The receive baseband processor 402 may be configured to process received OFDM signals or OFDMA signals by performing an FFT. In some embodiments, the receive baseband processor 402 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring back to FIG. 1, in some embodiments, the antennas 101 (FIG. 1) may each comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result. Antennas 101 may each include a set of phased-array antennas, although embodiments are not so limited.

Although the radio architecture 100 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

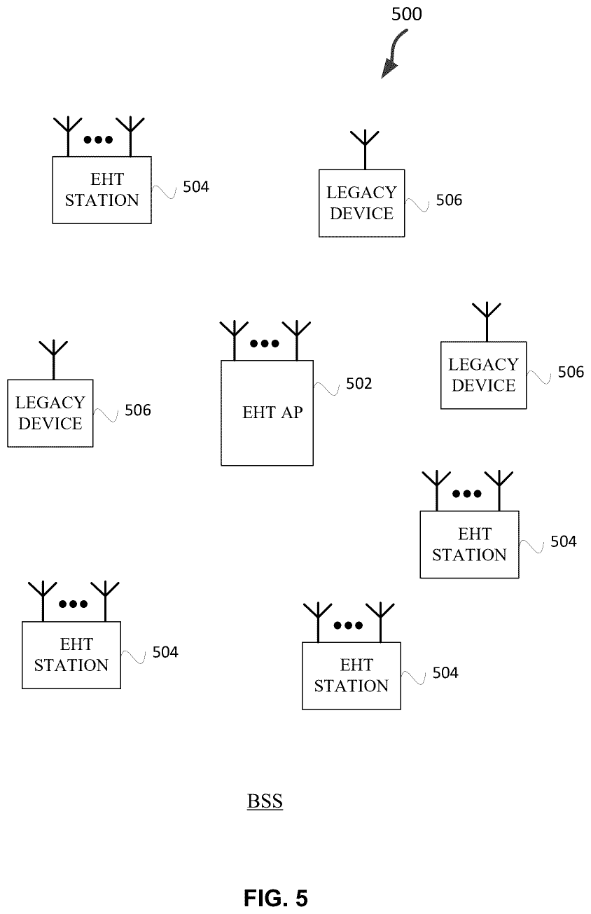

FIG. 5 illustrates a WLAN 500 in accordance with some embodiments. The WLAN 500 may comprise a basis service set (BSS) that may include an access point (AP) 502, which may be an AP, a plurality of stations 504, and a plurality of legacy (e.g., IEEE 802.11n/ac/ax) devices 506. In some embodiments, WLAN 500 may be configured for Extremely High Throughput (EHT) communications in accordance with the IEEE 802.11be standard and one or more stations including AP 502 and stations 504 may be EHT STAs. In some embodiments, WLAN 500 may be configured for Ultra-High Rate (UHR) communications in accordance with one of the IEEE 802.11 standards or draft standards and one or more stations including AP 502 and stations 504 may be UHR and/or UHR+STAs.

In some embodiments, WLAN 500 may be configured for next generation vehicle-to-everything (NGV) communications in accordance with the IEEE 802.11bd standard and one or more stations including AP 502 may be next generation vehicle-to-everything (NGV) stations (STAs).

The AP 502 may be an AP using the IEEE 802.11 to transmit and receive. The AP 502 may be a base station. The AP 502 may use other communications protocols as well as the IEEE 802.11 protocol. The IEEE 802.11 protocol may be IEEE 802.11ax. The IEEE 802.11 protocol may include using orthogonal frequency division multiple-access (OFDMA), time division multiple access (TDMA), and/or code division multiple access (CDMA). The IEEE 802.11 protocol may include a multiple access technique. For example, the IEEE 802.11 protocol may include space-division multiple access (SDMA) and/or multiple-user multiple-input multiple-output (MU-MIMO). There may be more than one AP 502 that is part of an extended service set (ESS). A controller (not illustrated) may store information that is common to the more than one APs 502.

The legacy devices 506 may operate in accordance with one or more of IEEE 802.11 wireless communication standard. The legacy devices 506 may be STAs or IEEE STAs. The STAs 504 may be wireless transmit and receive devices such as cellular telephone, portable electronic wireless communication devices, smart telephone, handheld wireless device, wireless glasses, wireless watch, wireless personal device, tablet, or another device that may be transmitting and receiving using the IEEE 802.11 protocol such as IEEE 802.11ax or another wireless protocol. In some embodiments, the STAs 504 may be termed high efficiency (HE) stations.

AP 502 may communicate with legacy devices 506 in accordance with legacy IEEE 802.11 communication techniques. In example embodiments, AP 502 may also be configured to communicate with STAs 504 in accordance with legacy IEEE 802.11 communication techniques.

In some embodiments, a frame may be configurable to have the same bandwidth as a channel. The frame may be a physical Layer Convergence Procedure (PLCP) Protocol Data Unit (PPDU). In some embodiments, there may be several types of PPDUs that may have different fields and different physical layers and/or different media access control (MAC) layers.

The bandwidth of a channel may be 20 MHz, 40 MHz, or 80 MHz, 160 MHz, 320 MHz contiguous bandwidths or an 80+80 MHz (160 MHz) non-contiguous bandwidth. In some embodiments, the bandwidth of a channel may be 1 MHz, 1.25 MHz, 2.03 MHz, 2.5 MHz, 4.06 MHz, 5 MHz and 10 MHz, or a combination thereof or another bandwidth that is less or equal to the available bandwidth may also be used. In some embodiments the bandwidth of the channels may be based on a number of active data subcarriers. In some embodiments the bandwidth of the channels is based on 26, 52, 106, 242, 484, 996, or 2×996 active data subcarriers or tones that are spaced by 20 MHz. In some embodiments the bandwidth of the channels is 256 tones spaced by 20 MHz. In some embodiments the channels are multiple of 26 tones or a multiple of 20 MHz. In some embodiments a 20 MHz channel may comprise 242 active data subcarriers or tones, which may determine the size of a Fast Fourier Transform (FFT). An allocation of a bandwidth or a number of tones or sub-carriers may be termed a resource unit (RU) allocation in accordance with some embodiments.

In some embodiments, the 26-subcarrier RU and 52-subcarrier RU are used in the 20 MHz, 40 MHz, 80 MHz, 160 MHz and 80+80 MHz OFDMA PPDU formats. In some embodiments, the 106-subcarrier RU is used in the 20 MHz, 40 MHz, 80 MHz, 160 MHz and 80+80 MHz OFDMA and MU-MIMO PPDU formats. In some embodiments, the 242-subcarrier RU is used in the 40 MHz, 80 MHz, 160 MHz and 80+80 MHz OFDMA and MU-MIMO PPDU formats. In some embodiments, the 484-subcarrier RU is used in the 80 MHz, 160 MHz and 80+80 MHz OFDMA and MU-MIMO PPDU formats. In some embodiments, the 996-subcarrier RU is used in the 160 MHz and 80+80 MHz OFDMA and MU-MIMO PPDU formats.

A frame may be configured for transmitting a number of spatial streams, which may be in accordance with MU-MIMO and may be in accordance with OFDMA. In other embodiments, AP 502, STA 504, and/or legacy device 506 may also implement different technologies such as code division multiple access (CDMA) 2000, CDMA 2000 1×, CDMA 2000 Evolution-Data Optimized (EV-DO), Interim Standard 2000 (IS-2000), Interim Standard 95 (IS-95), Interim Standard 856 (IS-856), Long Term Evolution (LTE), Global System for Mobile communications (GSM), Enhanced Data rates for GSM Evolution (EDGE), GSM EDGE (GERAN), IEEE 802.16 (i.e., Worldwide Interoperability for Microwave Access (WiMAX)), BlueTooth®, or other technologies.

Some embodiments relate to HE and/or EHT communications. In accordance with some IEEE 802.11 embodiments (e.g., IEEE 802.11ax embodiments) a AP 502 may operate as a primary station which may be arranged to contend for a wireless medium (e.g., during a contention period) to receive exclusive control of the medium for an control period. In some embodiments, the control period may be termed a transmission opportunity (TXOP). AP 502 may transmit a master-sync transmission, which may be a trigger frame or control and schedule transmission, at the beginning of the control period. AP 502 may transmit a time duration of TXOP and sub-channel information. During the control period, STAs 504 may communicate with AP 502 in accordance with a non-contention based multiple access technique such as OFDMA or MU-MIMO. This is unlike conventional WLAN communications in which devices communicate in accordance with a contention-based communication technique, rather than a multiple access technique. During the control period, the AP 502 may communicate with STAs 504 using one or more frames. During the control period, the STAs 504 may operate on a sub-channel smaller than the operating range of the AP 502. During the control period, legacy stations refrain from communicating. The legacy stations may need to receive the communication from the AP 502 to defer from communicating.

In accordance with some embodiments, during TXOP the STAs 504 may contend for the wireless medium with the legacy devices 506 being excluded from contending for the wireless medium during the master-sync transmission. In some embodiments the trigger frame may indicate an uplink (UL) UL-MU-MIMO and/or UL OFDMA TXOP. In some embodiments, the trigger frame may include a DL UL-MU-MIMO and/or DL OFDMA with a schedule indicated in a preamble portion of trigger frame.

In some embodiments, the multiple-access technique used during the TXOP may be a scheduled OFDMA technique, although this is not a requirement. In some embodiments, the multiple access technique may be a time-division multiple access (TDMA) technique or a frequency division multiple access (FDMA) technique. In some embodiments, the multiple access technique may be a space-division multiple access (SDMA) technique. In some embodiments, the multiple access technique may be a Code division multiple access (CDMA).

The AP 502 may also communicate with legacy devices 506 and/or non-legacy stations 504 in accordance with legacy IEEE 802.11 communication techniques. In some embodiments, the AP 502 may also be configurable to communicate with STAs 504 outside the TXOP in accordance with legacy IEEE 802.11 communication techniques, although this is not a requirement. Some embodiments are directed to an apparatus of a STA configured for operation in a WLAN comprising processing circuitry and memory. In some embodiments station 504 may be a “group owner” (GO) for peer-to-peer modes of operation. A wireless device may be a station 504 or a AP 502.

In some embodiments, the station 504 and/or AP 502 may be configured to operate in accordance with IEEE 802.11mc. In example embodiments, the radio architecture of FIG. 1 is configured to implement the station 504 and/or the AP 502. In example embodiments, the front-end module circuitry of FIG. 2 is configured to implement the station 504 and/or the AP 502. In example embodiments, the radio IC circuitry of FIG. 3 is configured to implement the station 504 and/or the AP 502. In example embodiments, the base-band processing circuitry of FIG. 4 is configured to implement the station 504 and/or the AP 502.

In example embodiments, the Stations 504, AP 502, an apparatus of the Stations 504, and/or an apparatus of the AP 502 may include one or more of the following: the radio architecture of FIG. 1, the front-end module circuitry of FIG. 2, the radio IC circuitry of FIG. 3, and/or the base-band processing circuitry of FIG. 4.

In example embodiments, the radio architecture of FIG. 1, the front-end module circuitry of FIG. 2, the radio IC circuitry of FIG. 3, and/or the base-band processing circuitry of FIG. 4 may be configured to perform the methods and operations/functions herein.

In example embodiments, the station 504 and/or the AP 502 are configured to perform the methods and operations/functions described herein. In example embodiments, an apparatus of the station 504 and/or an apparatus of the AP 502 are configured to perform the methods and functions described herein. The term Wi-Fi may refer to one or more of the IEEE 802.11 communication standards. AP and STA may refer to AP 502 and/or STA 504 as well as legacy devices 506.

In some embodiments, the AP and STAs may communicate in accordance with one of the IEEE 802.11 standards. IEEE Std 802.11-2020, IEEE P802.11ax/D8.0, October 2020, IEEE P802.11REVmd/D5.0, IEEE P802.11be/D7.0, August 2024 and IEEE P802.11-REVme/D1.3 are incorporated herein by reference in their entireties.

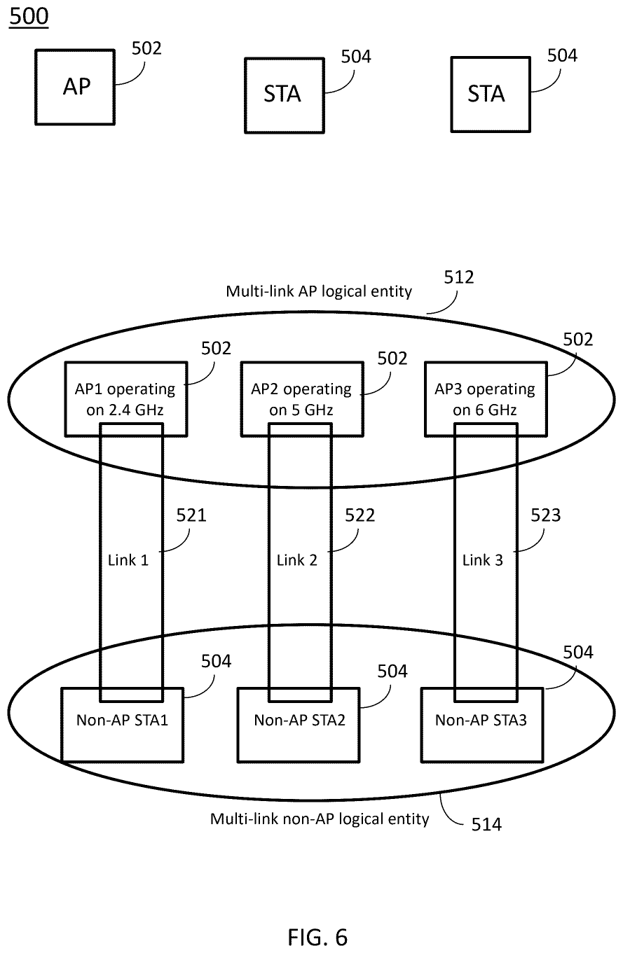

FIG. 6 illustrates a multi-link framework in accordance with some embodiments. The multi-link framework includes an access point (AP) multi-link device (AP MLD) 512 comprising a plurality of affiliated access point stations and a non-AP MLD 514 comprising a plurality of affiliated non-AP STAs. The AP MLD and the non-AP MLD may perform a multi-link setup procedure to set up the pairs of links 521, 522, 523 between the APs of the AP MLD 512 and corresponding non-AP STAs 504 of the non-AP MLD 514 to allow frames to be communicated between the non-AP MLD 514 and the AP MLD 512 using a single medium access control (MAC) service access point (SAP).

In some embodiments, the mobile device (e.g., the STA) may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), or other device that may receive and/or transmit information wirelessly. In some embodiments, the mobile device may include one or more of a keyboard, a display, a non-volatile memory port, multiple antennas, a graphics processor, an application processor, speakers, and other mobile device elements. The display may be an LCD screen including a touch screen.

The antennas may comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result.

Although the mobile device is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

Embodiments may be implemented in one or a combination of hardware, firmware and software. Embodiments may also be implemented as instructions stored on a computer-readable storage device, which may be read and executed by at least one processor to perform the operations described herein. A computer-readable storage device may include any non-transitory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. Some embodiments may include one or more processors and may be configured with instructions stored on a computer-readable storage device.

MAC header protection has been discussed in 802.11bn “11bn” to resolve various security issues due to some MAC header fields being masked from additional authentication data (AAD) to framebody protection. Fundamentally, framebody protection is handled by higher layer, so some MAC header are masked out during protection due to possibility of retransmitting frames. To protect the MAC header fields that are masked out, a specific lower layer security processing is then required. However, protecting MAC header by simply authenticating the MAC header with additional PN and MIC fields may not work. Note that his additional MIC check is required to be done before responding acknowledgement because acknowledge acks the frame with a specific sequence number/packet number (SN/PN) is received, but SN/PN is protected by the MAC header protection. To compute the MIC of MAC header protection early, it is also needed to know the key and corresponding key ID of the MAC header protection, but it has been hard to add key ID in addition fields of MAC header.

It was proposed to respond acknowledgement before checking the MIC of MAC header, but this creates attack on transmitter side, which may delete data or management frame due to ack for the wrong sequence number.

There are proposals to add padding only at the end of A-MPDUs, but this does not consider cases like usage of non-HT due to link adaptation to low rate or the need to check many MICs in the A-MPDU, where the checking time now scales with the number of MPDUs.

Example embodiments of the present disclosure relate to systems, methods, and devices for padding for MAC header protection.

In one embodiment, an enhanced MAC protection system may facilitate padding for non-HT format and padding between MPDUs to scale processing time with number of MICs in an A-MPDU.

MIC can be checked before responding with acknowledgement for any format including non-HT format and other format with A-MPDU. Further, the operation scales with the number of MICs in an A-MPDU.

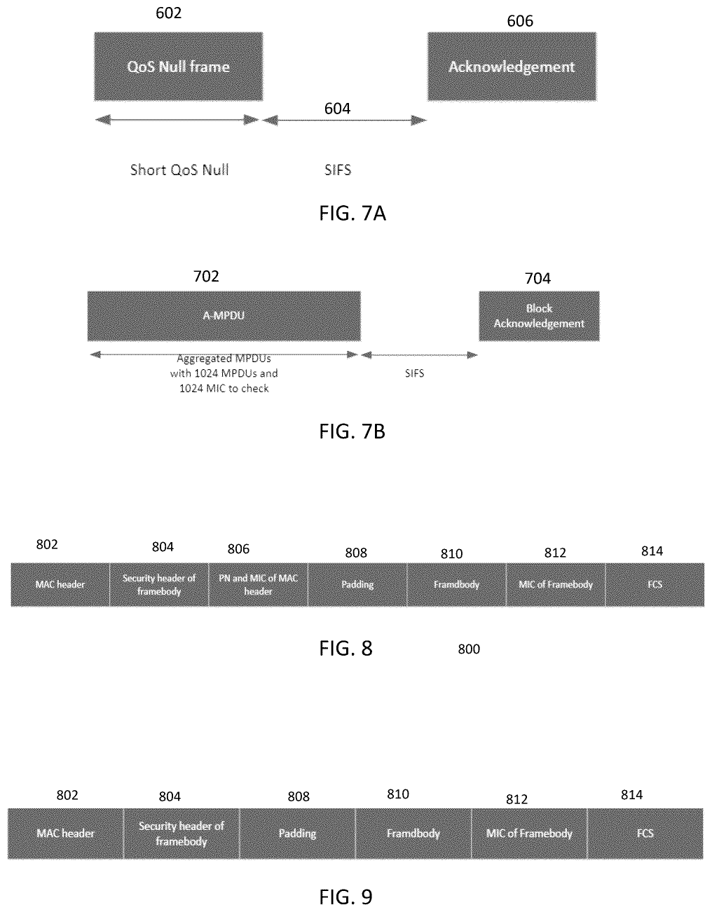

FIG. 7A illustrates a QoS Null frame transmission and an acknowledgement (ACK), in accordance with some embodiments.

It has been reported that it may be difficult to finish MIC check before responding acknowledgement. This problem is not just about key searching due to no early indication of key ID. The problem is more on catching up the MIC computation due to short transmission time like very high data rate and needs to respond acknowledgement very soon. For example, a QoS Null transmitted with highest data rate may leave very few time to compute MIC and responding Ack.

FIG. 7B illustrates an A-MPDU transmission and a corresponding block acknowledgement, in accordance with some embodiments. In this example, it is also possible that a series of 1024 MPDU with 1024 MIC needs to check before responding Acknowledgement.

FIG. 8 illustrates an MPDU that includes MAC header protection padding in accordance with some embodiments. For reception of an MAC Protocol Data Unit (MPDU), an ultra-high reliability station (UHR STA) is configured to encode a management frame for transmission to a UHR access point (UHR AP) indicating whether medium access control (MAC) header protection padding is being requested. The UHR STA decodes a protected control frame received from the UHR AP comprising an MPDU 800 that includes a MAC header protection padding field 808 when the MAC header protection padding has been requested. The MAC header protection padding field 808 may be included in the MPDU 800 after a MAC header field 802 and a security header of framebody field 804 and before a framebody field 810, a MIC of framebody field 812 and an FCS field 814 of the MPDU. The UHR STA may compute a message integrity code (MIC) based on the MAC header field 802 and the security header of framebody field 804 and compare the computed MIC with a MIC of the MAC header 806. The UHR STA may respond to the UHR AP with an acknowledge frame (ACK) after computing the MIC to acknowledge the MPDU 800, the ACK being sent an SIFS after receipt of the FCS field 814. In these embodiments the MAC header protection padding field 808 may comprises padding to allow for additional time for the processing circuitry to compute the MIC before sending the ACK.

In this example, starting the design with padding inside the MPDU, which will work for non-HT format. Have padding field after the PN and MIC field of the MAC header protection. An example is shown in FIG. 8. Both sides negotiated usage of padding by indicated required padding time for MAC header protection and the transmitter then adds padding based on the request of the receiver. The receiver knows the existence of the padding by looking at the RA/TA field for the frame.

The transmitter and receiver know the size of the padding by doing computation of size based on the indicated time and data rate. For example, padding size (in bytes)=padding indicate duration*data rate/8.

FIG. 9 illustrates an MPDU that includes MAC header protection padding in accordance with some other embodiments. In this example, the padding may even exist when PN and MIC does not exist to provide preparation of response frame to individually addressed data frame or management frame.

Both sides negotiated usage of padding by indicated required padding time for preparing required control frame response to the soliciting data/management frame and the transmitter then adds padding based on the request of the receiver.

The transmitter and receiver know the size of the padding by doing computation of size based on the indicated time and data rate. For example, padding size (in bytes)=padding indicate duration*data rate/8.

Continuing the design with padding based on A-MPDU delimiter, which will work for any format except non-HT format.

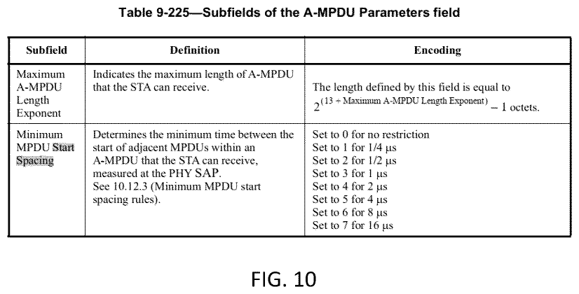

FIG. 10 is a table 9-255 that illustrates subfields of an A-MPDU parameters field in accordance with some embodiments. The example may utilize the existing MPDU start spacing mechanism to add spacing between MPDUs. Have a new MPDU start spacing indication to indicate what is not indicated in minimum MPDU start spacing. Some embodiments may have a MPDU SU Spacing Factor field to indicate a factor of MPDU spacing for SU. In some embodiments:
N bytes>=tMSS×2\hat{ }{MSSF}×r/8
tMSS is the time (in microseconds) for MPDU spacing
MSSF is the value indicated in MPDU SU Spacing Factor field.
R is the value of the PHY Data Rate (in Mb/s) defined in 19.5 (Parameters for HT MCSs) for HT PPDUs, in 21.5 (Parameters for VHT-MCSs) for VHT PPDUs, in 23.5 (Parameters for S1G-MCSs) for S1G PPDUs, and in Clause 20 (Directional multi-gigabit (DMG) PHY specification) for a DMG STA.
Define another padding mechanism to add A-MPDU delimiter padding at the end of the A-MPDU.
Both sides negotiate usage of padding by indicating required padding time at the end for A-MPDU reception and the transmitter then adds padding based on the request of the receiver.
Likely one field to indicate required padding time.
The padding at the end is also based on A-MPDU delimiter.

In accordance with embodiments, for reception of an MAC Protocol Data Unit (MPDU), an ultra-high reliability station (UHR STA) may encode a management frame for transmission to a UHR access point (UHR AP) indicating whether medium access control (MAC) header protection padding is being requested. The UHR STA decodes a protected control frame received from the UHR AP comprising an MPDU 800 (see FIG. 8) that includes a MAC header protection padding field 808 when the MAC header protection padding has been requested. The MAC header protection padding field 808 may be included in the MPDU 800 after a MAC header field 802 and a security header of framebody field 804 and before a framebody field 810, a MIC of framebody field 812 and an FCS field 814 of the MPDU. The UHR STA may compute a message integrity code (MIC) based on the MAC header field 802 and the security header of framebody field 804 and compare the computed MIC with a MIC of the MAC header 806. The UHR STA may respond to the UHR AP with an acknowledge frame (ACK) after computing the MIC to acknowledge the MPDU 800, the ACK being sent an SIFS after receipt of the FCS field 814. In these embodiments the MAC header protection padding field 808 may comprises padding to allow for additional time for the UHR STA to compute the MIC before sending the ACK.

In some embodiments, the management frame may be sent by the UHR STA prior to receipt of the protected control frame. In these embodiments, the management frame may be encoded to include a station capability element indicating whether the UHR STA has a capability for MAC header protection padding. In these embodiments, when the UHR STA has indicated the capability for MAC header protection padding, the station capability element may further be encoded to indicate whether the UHR STA is requesting use of MAC header protection padding. In some of these embodiments, when the UHR STA is requesting use of MAC header protection padding, the station capability element may further be encoded to include a requested amount of padding for inclusion in the MAC header protection padding field 808 of the MPDU 800. In some embodiments, after decoding the MAC header field 802 and the security header of framebody field 804 of the MPDU, the UHR STA may compute the MIC.

In some embodiments, the UHR STA may determine whether the MPDU 800 includes the MAC header protection padding field 808 based on one of a receiver address (RA) field and transmitter address (TA) field of the control frame.

In some embodiments, the UHR STA may determine the requested amount of padding based on a processing time for computation of the MIC (i.e., to allow for additional computation time before responding with an ACK).

In some embodiments, the size of the MAC header protection padding field 808 (e.g., in bytes) may be based on a required padding time and a data rate. For example, the padding size (in bytes)=padding indicate duration x data rate/8, although the scope of the embodiments is not limited in this respect.

In some embodiments, the UHR STA may request the MAC header protection padding for receipt of shorter frames including QoS Null frames that are transmitted at higher data rates. In these embodiments, the UHR STA may refrain from requesting the MAC header protection padding for longer frames (i.e., since there may be sufficient time to compute the MIC before sending the ACK). As illustrated in FIG. 7A, the UHR STA may request the MAC header protection padding for receipt of QoS Null frame 602 since there may be insufficient time to respond with ACK 606 an SIFS 604 after QoS Null frame 602. In this case, the UHR AP may include the MAC header protection padding field 808 in QoS Null frame 602 with a requested amount of padding.

In some embodiments, the UHR STA may determine that MAC header protection padding is needed when there is insufficient time for the UHR STA to compute the MIC and send the ACK back an SIFS after receipt of the FCS field 814 to the UHR AP to acknowledge the control frame. In these embodiments, the UHR STA may determine that MAC header protection padding is not needed when there is sufficient time to compute the MIC and send the ACK back to the UHR AP to acknowledge the control frame.

In some embodiments, when the MAC header protection padding is determined not to be needed by the UHR STA, the UHR STA may indicate in the station capability element of the management frame that the MAC header protection padding is not needed. In these embodiments, when the UHR STA has indicated that the MAC header protection padding is not needed, the MPDU 800 is received from the UHR AP without the MAC header protection padding field 808.

In some embodiments, the MPDU 800 may be one or a plurality of MPDUs in an aggregated MPDU (A-MPDU) 702 (see FIG. 7B) received from the UHR AP. In these embodiments, when the plurality of MPDUs have MAC header protection padding and include the MAC header protection padding field 808, the UHR STA may compute a MIC for each of the MPDUs prior to transmission of a block acknowledgement (Block ACK) 704 for the A-MPDU.

In some embodiments, for multi-link operation (MLO) in which a plurality of links is established between the UHR STA and the UHR AP, the UHR STA may decode a protected control frame received from the UHR AP on each of the links. Each protected control frame may comprise an MPDU 800 that includes a MAC header protection padding field 808 when MAC header protection padding is used.

In some embodiments, for MLO when MAC header protection padding is used, each link is configured with an independent replay counter and a different key is used for the protected control frame and a protected MAC header in each link. In these embodiments, the independent replay counter in each link is reset to zero when the key is derived or rekeyed and set to a packet or sequence number (PN or SN) of the protected control frame or protected MAC header when the MIC is verified.

In some embodiments, the UHR STA and UHR AP are configured to operate in accordance with an IEEE 802.11bn standard.

Some embodiments are directed to an ultra-high reliability access point (UHR AP). In these embodiments, for transmission of an MAC Protocol Data Unit (MPDU), the UHR AP may decode a management frame received from a UHR station (UHR STA). The management frame may indicate whether medium access control (MAC) header protection padding is being requested. The UHR AP may encode a protected control frame for transmission to the UHR STA. The protected control frame may comprise an MPDU 800 that includes a MAC header protection padding field 808 when the MAC header protection padding has been requested. In these embodiments, the MAC header protection padding field 808 may be included in the MPDU 800 after a MAC header field 802 and a security header of framebody field 804 and before a framebody field 810, a MIC of framebody field 812 and an FCS field 814 of the MPDU. In these embodiments, the UHR AP may decode an acknowledge frame (ACK) received from the UHR STA. In these embodiments, the MAC header protection padding field 808 may comprise padding to allow for additional time for the UHR STA to compute the MIC before sending the ACK.

In some embodiments, the management frame may be received from the UHR STA prior to receipt of the protected control frame. In these embodiments, the management frame may be encoded to include a station capability element indicating whether the UHR STA has a capability for MAC header protection padding. In these embodiments, when the UHR STA has indicated the capability for MAC header protection padding, the station capability element may further indicate whether the UHR STA is requesting use of MAC header protection padding. In these embodiments, when the UHR STA is requesting use of MAC header protection padding, the station capability element may further include a requested amount of padding for inclusion in the MAC header protection padding field 808 of the MPDU 800.

In some embodiments, for multi-link operation (MLO) in which a plurality of links is established between the UHR STA and the UHR AP, the UHR AP may encode a protected control frame for transmission to the UHR STA on each of the links. Each protected control frame may comprise an MPDU 800 that includes a MAC header protection padding field 808 when MAC header protection padding is used.

In some embodiments, for MLO when MAC header protection padding is used, the UHR AP may configure each link with an independent replay counter and a different key may be used for the protected control frame and a protected MAC header in each link. In these embodiments, the independent replay counter in each link may be reset to zero when the key is derived or rekeyed and may be set to a packet number (PN) or sequence number (SN) of the protected control frame or protected MAC header when the MIC is verified.

Control frame protection for control frame like Trigger frame, BA, and BAR have been proposed in UHR to resolve the security concern of unprotected control frame. MAC header protection has also been proposed in UHR to resolve the security concern of unprotected MAC header fields like PM, SN, HT control, etc.

Control frame and unprotected fields of MAC usually are usually handled in the lower MAC layer. For multi-link operation (MLO), where more than one link is established between two multi-link devices, different links will need a way to transmit/receive protected control frame or protected MAC header independently.

To achieve this goal, the management of the key and corresponding parameters used to protect control frame and MAC header transmit/received in each link under MLO is then crucial. The rekey procedure for the key also needs to be addressed.

It is possible to have a different key for control frame protection or MAC header protection in each link. Different keys will allow independent operation of each link.

It is possible to have the same key for control frame protection or MAC header protection in each link.

There are also existing rekey procedures for group key and the entire PTKSA.

If different key for control frame protection or MAC header protection in each link is used, then in general, the key in each link will be derived from PTKSA and be managed by the authenticator or supplicant, and maintaining a lot of separate keys is generally not preferred.

If the same key for control frame protection or MAC header protection in each link is used, then there are the questions of how to allow independent operation of parameters like PN assignment in each link.

Finally, the key for control frame protection or MAC header protection is likely to be derived from PTKSA for individually addressed frame, it is possible that the key for control frame protection or MAC header protection needs to be rekeyed, but the originally key like TK or KDK does not need to be rekeyed. A separate rekey procedure for the key derived from KDK without the need to rekey the entire PTKSA is then required.

Example embodiments of the present disclosure relate to systems, methods, and devices for key management for MAC header protection and control frame protection.

In one embodiment, a secure access framework system may facilitate details that for either MAC header protection or control frame protection.

If one key is used for individually addressed frame across links under multi-link operation (MLO), then:

In one embodiment, a secure access framework system may continue to use transmitter STA MAC address in the nonce.

In one embodiment, a secure access framework system may facilitate having independent PN assignment in each link of a transmitting MLD, e.g., a MLD transmits protected control frame or MAC header in each link.

In one embodiment, a secure access framework system may facilitate to have independent replay counter in each link of a receiving MLD, e.g., a MLD receives protected control frame or MAC header in each link.

In one embodiment, a secure access framework system may facilitate a rekey procedure for the key used by MAC header protection or control frame protection of individually addressed frame.

Since nonce is based on STA MAC address and PN, this ensures that there is no repeating nonce and allows independent PN assignment of transmitting MLD.

Independent replay counter allows independent replay check in each link without the need to sync across link for receiving MLD. Rekey for the key of MAC header protection or control frame protection of individually addressed frame can be done without rekey the whole PTKSA.

In one or more embodiments, details may be provided for either MAC header protection or control frame protection, if one key is used for individually addressed frame across links under MLO, then:

In one or more embodiments, a secure access framework system may continue to use transmitter STA MAC address in the nonce of the cipher.

In one or more embodiments, a secure access framework system may have independent PN assignment in each link of a transmitting MLD, i.e., a MLD transmits protected control frame or MAC header in each link. This means the same PN may be used in each link.

In one or more embodiments, a secure access framework system may have an independent replay counter in each link of a receiving MLD, i.e., a MLD receives protected control frame or MAC header in each link.

If different key is used for protected control frame and protected MAC header then different replay counter in each link is used

The replay counter in each link is reset to 0 when the key is derived or when rekey is done.

The replay counter is set to the PN of the received protected control frame or protected MAC header when the MIC is verified.

We continue with the key derivation of the key for MAC header protection or control frame protection for individually addressed frame:

The key is derived from KDK.

The key can be computed by either side of the authenticator or supplicant and sent to the peer.

The key is derived with input of Authenticator Nonce (ANonce) from the authenticator.

The key is derived with input of Supplicant Nonce (SNonce) from the supplicant.

The key is derived with specific input string for MAC header protection for MAC header protection key.

The key is derived with specific input string for control frame protection for control frame protection key.

The key is derived with input of Authenticator address (AA) and Supplicant address (SA). Examples of MAC header protection are the following:
Example 1: KDF-Hash-Length(KDK, “MAC header Temporal Key”, Min(AA,SPA)∥
Max(AA,SPA)∥Min(ANonce,SNonce)∥Max(ANonce,SNonce)
Example 2: KDF-Hash-Length(KDK, “MAC header Temporal Key”, Min(AA,SPA)∥
Max(AA,SPA)∥ANonce
Example 3: KDF-Hash-Length(KDK, “MAC header Temporal Key”, Min(AA,SPA)∥
Max(AA,SPA)∥SNonce
Examples of control frame protection are the following
Example 1: KDF-Hash-Length(KDK, “Control frame Temporal Key”, Min(AA,SPA)∥
Max(AA,SPA)∥Min(ANonce,SNonce)∥Max(ANonce,SNonce)
Example 2: KDF-Hash-Length(KDK, “Control frame Temporal Key”, Min(AA,SPA)∥
Max(AA,SPA)∥ANonce
Example 3: KDF-Hash-Length(KDK, “Control frame Temporal
Key”, Min(AA,SPA)∥
Max(AA,SPA)∥SNonce

KDF-Hash-Length is the key derivation function as defined in 12.7.1.6.2 (Key derivation function (KDF)) using the hash algorithm identified by the AKM suite selector (see Table 9-190 (AKM suite selectors)).

Length is the total number of bits to derive.

We continue with the rekey operation of the key for MAC header protection or control frame protection:

Have request/response frame to enable rekey operation.

The request/response frame can be.

EAPOL key data frame protected by encryption.

The management frame is protected by PMF.

The management frame is intended for MLD and can be sent in any link.

Both an authenticator or a supplicant can initiate the rekey procedure by sending the request frame.

The entity that sends the request frame is the initiator.

The entity that sends the response frame is the responder.

Have Key nonce field in the request frame and response frame.

If sent by Authenticator, includes ANonce.

If sent by Supplicant, includes SNonce.

If there is an ongoing PTKSA rekey using EAPOL key frame, then the request frame is rejected.

In the .request frame, can indicate the key to be used after rekey.

Have a field to indicate the key.

In the request frame, indicate the current key ID to be rekeyed or the key ID for the new key.

In the request frame, indicate which individually addressed key needs to be rekeyed.

A bitmap where each bit represents a key to be rekey can be reused.

Can indicate key for WUR, key for control frame protection or key for MAC header protection.

Two options to install the key to receive and transmit:

### Option 1: Time Approach:

Initiator indicates required time in request frame to install the key.

Responder indicates required time in response frame to install the key.

Initiator installs the new key for transmit and receive after sending Acknowledgement for the second message plus max (required time for initiator, required time for responder)

If initiator receives another retransmission of the second message, recompute the time to install the new key.

Responder installs the new key for transmit and receive after receiving Acknowledgement for the second message plus max (required time for initiator, required time for responder).

For this approach, remove key ID indication in the individually addressed MAC header protection or in the individually addressed control frame protection.

### Option 2: Two Key ID Approach:

The responder installs the new key to receive before sending the second message, i.e., the response frame.

Option 2.1: The initiator installs the new key to receive before sending the first message, i.e., the request frame, if first message indicates the key.

The initiator installs the new key to transmit after sending the Acknowledgement for the second message.

The responder installs the new key to receive after receiving the Acknowledgement for the second message.

Option 2.2: The initiator sends another confirm frame to the responder, and the initiator installs the new key to receive before sending the third message, i.e., the confirm frame.

The responder installs the new key to transmit after sending the Acknowledgement for the confirmation message.

The initiator installs the new key to transmit after receiving the Acknowledgement for the confirm message.

For this approach, Key ID indication in the individually addressed MAC header protection or control frame protection is required.

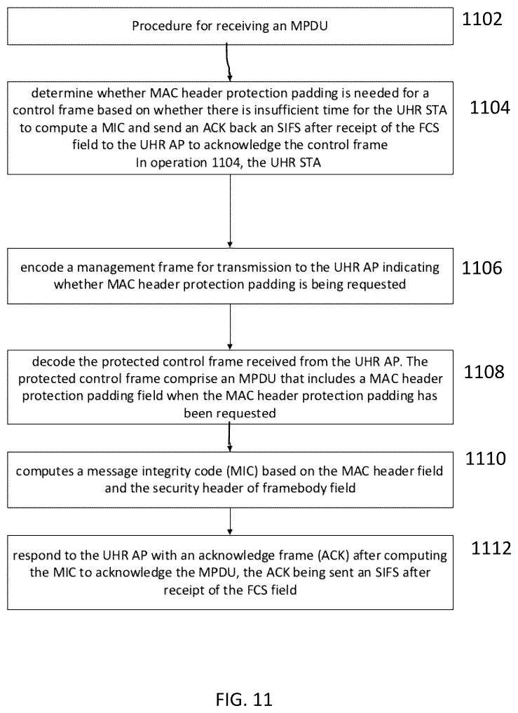

FIG. 11 is a procedure performed by a UHR STA for receiving an MPDU, in accordance with some embodiments.

In operation 1102, the UHR STA determines whether MAC header protection padding is needed for a control frame based on whether there is insufficient time for the UHR STA to compute a MIC and send an ACK back an SIFS after receipt of the FCS field to the UHR AP to acknowledge the control frame.

In operation 1104, the UHR STA encodes a management frame for transmission to the UHR AP indicating whether MAC header protection padding is being requested.

In operation 1106, the UHR STA decodes the protected control frame received from the UHR AP. The protected control frame comprise an MPDU that includes a MAC header protection padding field when the MAC header protection padding has been requested. The MAC header protection padding field is included in the MPDU after a MAC header field and a security header of framebody field and before a framebody field, a MIC of framebody field and an FCS field of the MPDU.

In operation 1108, the UHR STA computes a message integrity code (MIC) based on the MAC header field and the security header of framebody field.

In operation 1110, the UHR STA responds to the UHR AP with an acknowledge frame (ACK) after computing the MIC to acknowledge the MPDU, the ACK being sent an SIFS after receipt of the FCS field.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An apparatus of an ultra-high reliability station (UHR STA), the apparatus comprising: processing circuitry; and memory, wherein for reception of an MAC Protocol Data Unit (MPDU), the processing circuitry is configured to:
encode a management frame for transmission to a UHR access point (UHR AP), the management frame indicating whether medium access control (MAC) header protection padding is being requested;
decode a protected control frame received from the UHR AP, the protected control frame comprising an MPDU that includes a MAC header protection padding field when the MAC header protection padding has been requested, the MAC header protection padding field included in the MPDU after a MAC header field and a security header of framebody field and before a framebody field, a MIC of framebody field and an FCS field of the MPDU;
compute a message integrity code (MIC) based on the MAC header field and the security header of framebody field and compare the computed MIC with a MIC of the MAC header; and
respond to the UHR AP with an acknowledge frame (ACK) after computing the MIC to acknowledge the MPDU, the ACK being sent an SIFS after receipt of the FCS field,
wherein the MAC header protection padding field comprises padding to allow for additional time for the processing circuitry to compute the MIC before sending the ACK.

2. The apparatus of claim 1, wherein the management frame is sent by the UHR STA prior to receipt of the protected control frame, and
wherein the management frame is encoded to include a station capability element indicating whether the UHR STA has a capability for MAC header protection padding,
wherein when the UHR STA has indicated the capability for MAC header protection padding, the station capability element is further encoded to indicate whether the UHR STA is requesting use of MAC header protection padding, and
wherein when the UHR STA is requesting use of MAC header protection padding, the station capability element is further encoded to include a requested amount of padding for inclusion in the MAC header protection padding field of the MPDU.

3. The apparatus of claim 2, wherein after decoding the MAC header field and the security header of framebody field of the MPDU, the processing circuitry of the UHR STA is configured to compute the MIC.

4. The apparatus of claim 3, wherein the processing circuitry of the UHR STA is further configured to determine whether the MPDU includes the MAC header protection padding field based on one of a receiver address (RA) field and transmitter address (TA) field of the control frame.

5. The apparatus of claim 3, wherein the processing circuitry of the UHR STA is further configured to determine the requested amount of padding based on a processing time for computation of the MIC.

6. The apparatus of claim 5, wherein a size of the MAC header protection padding field is based on a required padding time and a data rate.

7. The apparatus of claim 5, wherein the processing circuitry of the UHR STA is configured to request the MAC header protection padding for receipt of shorter frames including QoS Null frames that are transmitted at higher data rates, and configured to refrain from requesting the MAC header protection padding for longer frames.

8. The apparatus of claim 5, wherein processing circuitry of the UHR STA is further configured to:
determine that MAC header protection padding is needed when there is insufficient time for the UHR STA to compute the MIC and send the ACK back an SIFS after receipt of the FCS field to the UHR AP to acknowledge the control frame, and determine that MAC header protection padding is not needed when there is sufficient time to compute the MIC and send the ACK back to the UHR AP to acknowledge the control frame.

9. The apparatus of claim 8, wherein when the MAC header protection padding is determined not to be needed by the UHR STA, the processing circuitry of the UHR STA is configured to indicate in the station capability element of the management frame that the MAC header protection padding is not needed, and
wherein when the UHR STA has indicated that the MAC header protection padding is not needed, the MPDU is received from the UHR AP without the MAC header protection padding field.

10. The apparatus of claim 2, wherein the MPDU is one or a plurality of MPDUs in an aggregated MPDU (A-MPDU) received from the UHR AP, and
wherein when the plurality of MPDUs have MAC header protection padding and include the MAC header protection padding field, the processing circuitry is configured to compute a MIC for each of the MPDUs prior to transmission of a block acknowledgement (Block ACK) for the A-MPDU.

11. The apparatus of claim 2, wherein for multi-link operation (MLO) in which a plurality of links is established between the UHR STA and the UHR AP, the processing circuitry of the UHR STA is configured to:
decode a protected control frame received from the UHR AP on each of the links, each protected control frame comprising an MPDU that includes a MAC header protection padding field when MAC header protection padding is used.

12. The apparatus of claim 11, wherein for the MLO when the MAC header protection padding is used, each link is configured with an independent replay counter and a different key is used for the protected control frame and a protected MAC header in each link, and
wherein the independent replay counter in each link is reset to zero when the key is derived or rekeyed and set to a packet or sequence number (PN or SN) of the protected control frame or protected MAC header when the MIC is verified.

13. The apparatus of claim 1 wherein the UHR STA and UHR AP are configured to operate in accordance with an IEEE.11bn standard.

14. A non-transitory computer-readable storage medium that stores instructions for execution by processing circuitry of an ultra-high reliability station (UHR STA), wherein for reception of an MAC Protocol Data Unit (MPDU), the processing circuitry is configured to:
encode a management frame for transmission to a UHR access point (UHR AP), the management frame indicating whether medium access control (MAC) header protection padding is being requested;
decode a protected control frame received from the UHR AP, the protected control frame comprising an MPDU that includes a MAC header protection padding field when the MAC header protection padding has been requested, the MAC header protection padding field included in the MPDU after a MAC header field and a security header of framebody field and before a framebody field, a MIC of framebody field and an FCS field of the MPDU;
compute a message integrity code (MIC) based on the MAC header field and the security header of framebody field and compare the computed MIC with a MIC of the MAC header; and
respond to the UHR AP with an acknowledge frame (ACK) after computing the MIC to acknowledge the MPDU, the ACK being sent an SIFS after receipt of the FCS field,
wherein the MAC header protection padding field comprises padding to allow for additional time for the processing circuitry to compute the MIC before sending the ACK.

15. The non-transitory computer-readable storage medium of claim 14, wherein the management frame is sent by the UHR STA prior to receipt of the protected control frame, and
wherein the management frame is encoded to include a station capability element indicating whether the UHR STA has a capability for MAC header protection padding,
wherein when the UHR STA has indicated the capability for MAC header protection padding, the station capability element is further encoded to indicate whether the UHR STA is requesting use of MAC header protection padding, and wherein when the UHR STA is requesting use of MAC header protection padding, the station capability element is further encoded to include a requested amount of padding for inclusion in the MAC header protection padding field of the MPDU.

16. The non-transitory computer-readable storage medium of claim 15, wherein processing circuitry of the UHR STA is further configured to:
determine that MAC header protection padding is needed when there is insufficient time for the UHR STA to compute the MIC and send the ACK back an SIFS after receipt of the FCS field to the UHR AP to acknowledge the control frame, and determine that MAC header protection padding is not needed when there is sufficient time to compute the MIC and send the ACK back to the UHR AP to acknowledge the control frame.

17. An apparatus of an ultra-high reliability access point (UHR AP), the apparatus comprising: processing circuitry; and memory, wherein for transmission of an MAC Protocol Data Unit (MPDU), the processing circuitry is configured to:
decode a management frame received from a UHR station (UHR STA), the management frame indicating whether medium access control (MAC) header protection padding is being requested;
encode a protected control frame for transmission to the UHR STA, the protected control frame comprising an MPDU that includes a MAC header protection padding field when the MAC header protection padding has been requested, the MAC header protection padding field included in the MPDU after a MAC header field and a security header of framebody field and before a framebody field, a MIC of framebody field and an FCS field of the MPDU; and
decode an acknowledge frame (ACK) received from the UHR STA the ACK being sent an SIFS after receipt of the FCS field,
wherein the MAC header protection padding field comprises padding to allow for additional time for the UHR STA to compute the MIC before sending the ACK.

18. The apparatus of claim 17, wherein the management frame is received from the UHR STA prior to receipt of the protected control frame, and
wherein the management frame is encoded to include a station capability element indicating whether the UHR STA has a capability for MAC header protection padding,
wherein when the UHR STA has indicated the capability for MAC header protection padding, the station capability element further indicates whether the UHR STA is requesting use of MAC header protection padding, and
wherein when the UHR STA is requesting use of MAC header protection padding, the station capability element further includes a requested amount of padding for inclusion in the MAC header protection padding field of the MPDU.

19. The apparatus of claim 18, wherein for multi-link operation (MLO) in which a plurality of links is established between the UHR STA and the UHR AP, the processing circuitry of the UHR AP is configured to:
encode a protected control frame for transmission to the UHR STA on each of the links, each protected control frame comprising an MPDU that includes a MAC header protection padding field when MAC header protection padding is used.

20. The apparatus of claim 19, wherein for the MLO when MAC header protection padding is used, the processing circuitry of the UHR AP is to configure each link with an independent replay counter and a different key is used for the protected control frame and a protected MAC header in each link, and
wherein the independent replay counter in each link is reset to zero when the key is derived or rekeyed and set to a packet or sequence number (PN or SN) of the protected control frame or protected MAC header when the MIC is verified.
